(19) United States
(12) Patent Application Publication
(10) Pub. No.: US 2023/0177362 A1
(43) Pub. Date: Jun. 8, 2023

(54) RISK ASSESSMENT APPARATUS, RISK ASSESSMENT METHOD, AND PROGRAM

(71) Applicant: NEC Corporation, Minato-ku, Tokyo (JP)

(72) Inventor: Yoshihiro OKADA, Tokyo (JP)

(73) Assignee: NEC Corporation, Minato-ku, Tokyo (JP)

(21) Appl. No.: 17/911,715

(22) PCT Filed: Mar. 30, 2020
(86) PCT No.: PCT/JP2020/014663

§ 371 Date: Sep. 15, 2022

(51) Int. Cl. G06N 5/02

(52) U.S. Cl. CPC G06N 5/027

(57) ABSTRACT

There is provided a risk assessment apparatus having a model acquisition part that acquires at least one explainable predictive model; a risk determination part that determines risk in the at least one model on the basis of the at least one model and ethical risk factor information, which is information that is an ethical risk factor; a model selection part that selects a model on the basis of the result of risk determination; and a model output part that outputs the selected model.

### TECHNICAL FIELD

The present invention relates to an apparatus that assesses ethical risk in an explainable predictive model and the like, and a method and program that assess the ethical risk.

### BACKGROUND

Conventional AI systems and the predictive models generated by the analysis engines thereof are of black-box type in which the model structure and the basis for decision-making are hidden. For this reason, it is difficult for humans to decide whether to adopt a model, and as a result, corporations and the like have faced the difficulty of employing and utilizing a model. In recent years, however, we have seen white box type AI systems and the analysis engines thereof that can output predictive models with structures and bases for decision-making interpretable by humans, and it has become possible to solve the above problems.

Patent Literature (PTL) 1 discloses an information processing system capable of generating an explanatory text in natural language about a feature value (candidate explanatory variable) in a predictive model and a feature value generation function that generates the feature value. Specifically, the feature value generation function is generated by plugging in a received explanatory variable and a value in a table that includes a target variable into a predetermined template, and a feature value is calculated by applying this function to the table. The explanatory text is generated by plugging in the feature value generation function and the calculated feature value into another template.

### CITATION LIST

### Patent Literature

### [Patent Literature 1]

International Publication Number WO2018/180970

### [Patent Literature 2]

Japanese Patent Kokai Publication No. JP2019-125240A

### [Patent Literature 3]

Japanese Patent Kokai Publication No. JP2005-071062A

### [Patent Literature 4]

Japanese Patent Kokai Publication No. JP2003-006221A

### SUMMARY

### Technical Problem

Each disclosure of Patent Literatures 1 to 4 cited above is incorporated herein in its entirety by reference thereto.

The following analysis was made by the inventor of the present invention.

Since white-box AI systems and models applied to the analysis engines thereof are explainable, it will be apparent if the model is unethical or is based on something that has an adverse effect on individuals or society, depending on the characteristics of the explanatory variables used and a combination of the explanatory variables. If this happens, it will be taken up as an issue, and the credibility of the corporate system to which the model is applied and of the apparatus that utilizes the AI system may be undermined. In recent years, there has been a lot of discussion on ethical concerns of AI and how to deal with these concerns, and once a corporation puts itself in a situation where it risks its credibility, the corporation may not be able to continue conducting business. Further, ethics vary by country and linguistic area, and often so does the impact thereof. Therefore, there are many risks involved in adopting a model, and one must address each of them.

In order to avoid such risks, one can implement a process of assessing the magnitude of risk before a model is applied to a system, and then it becomes possible to detect whether or not the model has a risk from an ethical point of view, know the magnitude of the risk in advance, and avoid adopting high-risk models. However, model components, including explanatory variables, generated by an AI framework are often diverse, and the number of assessed models, generated by combining these components, would be large. Further, as mentioned above, since each country or linguistic area, to which a model is applied, has a different assessment framework for the same model, the eventual number of models to be assessed would be immense.

Against this background, it is an object of the present invention to provide an assessment apparatus, assessment method, and program that can contribute to efficient and reliable assessment of risk in a model implemented in a white-box AI system or analysis engine.

### Solution to Problem

According to a first aspect of the present disclosure, there is provided a risk assessment apparatus comprising: a model acquisition part that acquires at least one explainable predictive model; a risk determination part that determines risk in the at least one model on the basis of the at least one model and ethical risk factor information, which is information that is an ethical risk factor; a model selection part that selects a model on the basis of the result of risk determination; and a model output part that outputs the selected model.

According to a second aspect of the present disclosure, there is provided a risk assessment method comprising: acquiring at least one explainable predictive model; determining risk in the at least one model on the basis of the acquired model and ethical risk factor information, which is information that is an ethical risk factor; selecting a model on the basis of the result of risk determination; and outputting the selected model.

According to a third aspect of the present disclosure, there is provided a program causing a computer to execute: a process of acquiring at least one explainable predictive model; a process of determining risk in the at least one model on the basis of the acquired model and ethical risk factor information, which is information that is an ethical risk factor; a process of selecting a model on the basis of the result of risk determination; and a process of outputting the selected model. The program can be provided being stored in a recording medium.

### Advantageous Effects of Invention

According to the present disclosure, it becomes possible to contribute to efficient and reliable assessment of risk in a model implemented in a white-box AI system or analysis engine. Still other features and advantages of the present invention will become readily apparent to those skilled in this art from the following detailed description in conjunction with the accompanying drawings wherein only example embodiments of the present invention are shown and described, by way of illustration of example embodiments or examples contemplated of carrying out this invention. As will be realized, the present invention is capable of other and different embodiments, and its several details are capable of modifications in various obvious respects, all without departing from the invention. Accordingly, the drawing and description are to be regarded as illustrative in nature, and not as restrictive

### BRIEF DESCRIPTION OF THE DRAWINGS

FIG. 1 is a drawing showing an example of a functional block of a risk assessment apparatus according to an example embodiment of the present disclosure.

FIG. 2 is a drawing showing the configuration of a risk assessment apparatus according to Example Embodiment 1.

FIG. 3 is a flowchart showing the operation of the risk assessment apparatus according to Example Embodiment 1.

FIG. 4 is a drawing showing an outline of the hardware configuration of the risk assessment apparatus according to Example Embodiment 1.

FIG. 5 is a drawing showing the configuration of a risk assessment apparatus according to Example Embodiment 2.

FIG. 6 is a drawing showing an example of a model selection rule stored in a model selection rule holding part of Example Embodiment 2.

FIG. 7 is a flowchart showing the operation of the risk assessment apparatus according to Example Embodiment 2.

### DESCRIPTION OF EXAMPLE EMBODIMENTS

First, an outline of an example embodiment will be given. It should be noted that the drawing reference signs in the outline are given to each element for convenience as an example to facilitate understanding, and the description in this outline is not intended to be any limitation.

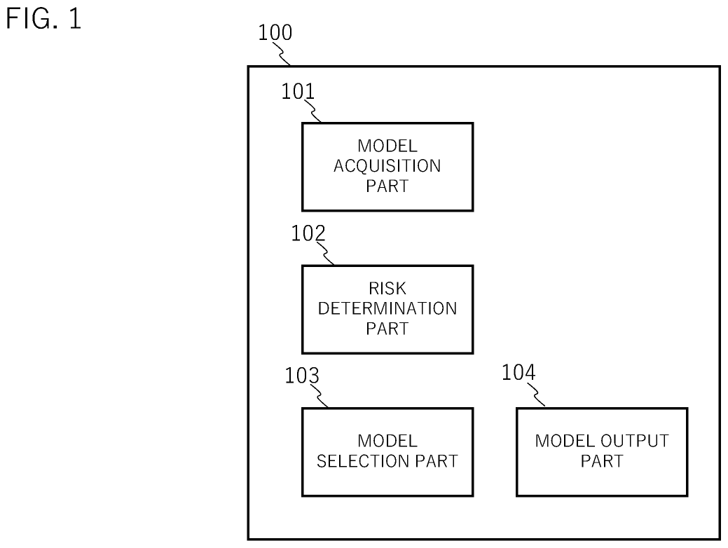

FIG. 1 shows an example of a block diagram of a risk assessment apparatus according to an example embodiment. The risk assessment apparatus 100 relating to an example embodiment has a model acquisition part 101 that acquires at least one explainable predictive model, a risk determination part 102 that determines risk in the at least one model on the basis of the acquired model and ethical risk factor information, which is information that is an ethical risk factor, a model selection part 103 that selects a model on the basis of the result of risk determination, and a model output part 104 that outputs the selected model.

The risk assessment apparatus relating to an example embodiment is able to determine the magnitude of risk from an ethical point of view in each of at least one explainable predictive model, select a model according to the determination result, and output the selected model. Therefore, it becomes possible to provide an efficient and reliable model.

Specific example embodiments will be described below in more detail with reference to the drawings. Note that the same reference signs are given to the same elements in each example embodiment, and the description thereof will be omitted.

### First Example Embodiment

A risk assessment apparatus relating to a first example embodiment will be described in more detail with reference to the drawings.

### [Model Acquisition Part]

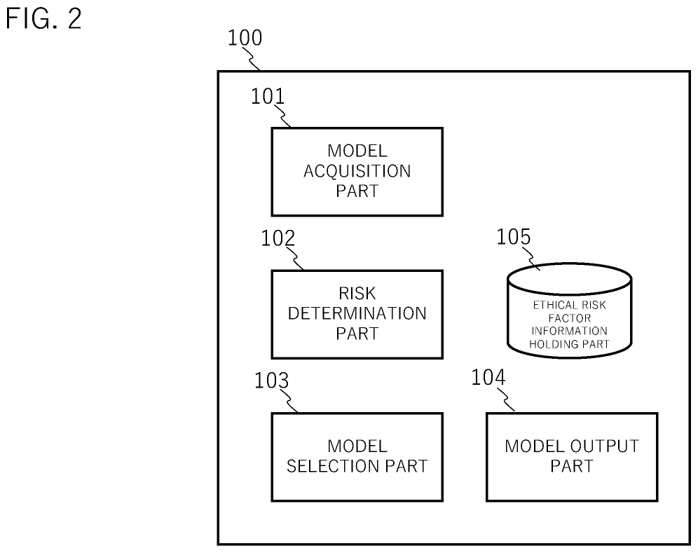

FIG. 2 shows an example of a block diagram of the risk assessment apparatus according to the present example embodiment. The model acquisition part 101 acquires at least one explainable predictive model. In the present disclosure, a “predictive model” denotes a model capable of predicting and outputting a value from some input according to learning results. In the present disclosure, “explainable” means that it is possible to present the rationale that led a predictive model to output a certain value. This implies that, for instance, the relationship between elements in the model such as ones between explanatory variables and between an explanatory variables and a target variable can be understood. For instance, here is an example of a model with respect to recruitment that predicts (determines) whether or not an applicant is employed: y=ax₁+bx₂+cx₃ (y: employment determination value; x₁: research subject; x₂: age; x₃: test score). The coefficients a, b, and c are determined through learning. If the value of y is greater than or equal to a predetermined value, the applicant is hired, and if the value is less than the predetermined value, he or she is rejected.

In the present disclosure, “acquiring a model” means receiving information representing a model as an input from a system or module that executes model generation or learning processing. An acquired model is stored in storage. In the above example, the variables y, x₁, x₂, and x₃ and the coefficients a, b, and c are stored. In addition, each variable (x₁, x₂, x₃) is stored in association with the descriptive item name of the variable (“research subject,” “age,” “test score,” etc.).

According to the present disclosure, as a recording medium used for the storage, a non-transitory computer-readable recording medium such as semiconductor storage (for instance, ROM (Read-Only Memory), RAM (Random Access Memory), and EEPROM (Electrically Erasable Programmable Read-Only Memory)), HDD (Hard Disk Drive), CD (Compact Disc), or DVD (Digital Versatile Disc) may be used, and the program according to the third aspect of the present disclosure may be saved and stored.

A predictive model may be constituted by apparent observed variables such as x₁, x₂, x₃ described above or may be a latent variable model (for instance, the strength of motivation for employment can be a variable) such as a factor analysis model. Further, in addition to linear models, non-linear models can also be applicable to the present disclosure.

Further, the model acquisition part 101 may assess a model received as an input using a predetermined method, only acquire a model that satisfies a predetermined value as a result of the assessment, and outputs the acquired model to the risk determination part 102 before the risk determination part 102 calculates a score. For instance, a generated model may be assessed according to an information criterion such as AIC (Akaike's Information Criterion), and models having values lower than a predetermined value may be adopted.

### [Risk Determination Part]

The risk determination part 102 determines risk in at least one model acquired by the model acquisition part 101 on the basis of the at least one model and ethical risk factor information, which is information that is an ethical risk factor. “Determining” denotes presenting the degree of risk using some index as a risk determination result. A risk determination result is presented using various methods such as a numerical score calculated by a predetermined method or the degree of risk shown in several assessment levels.

The ethical risk factor information is information that requires a certain amount of consideration in its handling and includes risks that, when variables representing the information are applied to a model as explanatory variables, the characteristics of the variables or a combination thereof may be unethical or have an adverse effect on individuals or society. The above risks include those that adversely affect the business of a corporation. In other words, if a predictive model with such risks is incorporated into a system, it may become widely known in the media as a system or service with ethical issues after its release. If this happens, not only may the system or service be forced to be suspended, which will damage the trust of users, but also a large amount of compensation may be demanded, causing losses. Examples of the ethical risk factor information include information with respect to race, gender, nationality, age, employment status, birthplace, residence, gender minority status, religion, physical/intellectual disability, ideology, etc. It should be noted that these are merely examples and the ethical risk factor information is not limited thereto.

The ethical risk factor information is provided as language or numerical data. These data may be configured to be accumulated in a database inside the apparatus. In this case, the apparatus may be configured to have an ethical risk factor information holding part 105 that holds the ethical risk factor information. Further, the ethical risk factor information may be stored in an external database on the Internet, and the information may be acquired via a search engine. The data may be held in the form of document or may be stored in a list format such as a dictionary. Further, language data such as documents, words, and phrases may be held as feature values expressed by numerical values in a plurality of dimensions.

As described above, a risk determination result may be obtained as a score. A model acquired by the model acquisition part 101 is received as an input and is scored using the components and ethical risk factor information thereof. In the acquired model, variables and the item names thereof are associated with each other, and a value such as the number of search hits or a search hit rate can be obtained by using the item names and searching the database that holds the ethical risk factor information. A model can be selected by outputting this value as the risk determination score to the model selection part 103.

The risk determination part 102 may have a function of generating a sentence that describes a model in a language for each of at least one model acquired on the basis of the relationship between elements in the at least one model and calculating a risk determination score assessing the at least one model using at least one of the sentence and an element in the sentence, and the ethical risk factor information.

More specifically, on the basis of the relationship between elements in the at least one model acquired, a sentence describing a model in a language is generated for each of the at least one model. For instance, in the model y=ax₁+bx₂+cx₃ described above, since y, x₁, x₂, and x₃ are associated with the item names “employment determination value,” “research subject,” “age,” and “test score,” respectively, and y and the linear expression for x are connected by an equal sign, it can be recognized that the target variable is y and the explanatory variable is x. Then, one can select a phrase template in natural language, “The target variable is determined (predicted) by the explanatory variable” and generate a sentence, “The employment determination value is determined (predicted) by the research subject, the age, and the test score.”

It is possible to grasp the characteristics of a model at a glance by generating a sentence in natural language describing the relationship between the explanatory variable and the target variable. Further, in the present disclosure, a risk determination score may be calculated by using this sentence and the ethical risk factor information.

Although the risk determination part 102 generates a sentence in natural language in the example above, it does not necessarily have to be in natural language. The risk determination part 102 may generate a sentence in a constructed language such as a programming language or XML that can be processed by a computer, for instance. Further, the sentence may be generated not only in Japanese, but also in other languages such as English. One can determine in which language the sentence should be generated by acquiring locale information of the generated model, and the risk determination part 102 can be configured as such.

When the sentence is generated as described above, the risk determination part 102 can obtain a risk determination result by using at least one of the generated sentence and an element in the generated sentence, and the ethical risk factor information.

For instance, if the example sentence above, “The employment determination value is determined (predicted) by the research subject, the age, and the test score,” is generated, the similarity between the characteristics of the sentence and the characteristics of the ethical risk factor information can be determined, and a risk determination score can be calculated according to the frequency of predetermined similarities.

As described, the risk determination part 102 calculates a risk determination score by calculating a statistical value indicating the relationship between at least one of the generated sentence and an element in the generated sentence, and the stored ethical risk factor information. Various types of “statistical values” can be considered. In terms of the relationship between the generated sentence and a document in the information, the configurations below may be adopted. For instance, the “statistical value” may be obtained as follows: 1. The sum of the similarities based on the value of the inner product between a feature vector of the generated sentence and a feature vector of a document in the information, or the frequency of documents with a similarity equal to or greater than a predetermined value is obtained; 2. The similarity (distance) between a feature vector of the generated sentence and a feature vector of a document in the information is derived, documents are clustered using a predetermined algorithm (hierarchical clustering, k-means clustering, etc.) on the basis of this similarity (distance), and the frequency of documents in a cluster, to which the generated sentence belongs, is obtained; 3. Documents are categorized by applying a feature vector of the generated sentence to a predetermined classification method (discriminant analysis, decision tree, trained neural network model, etc.) for classifying documents into a plurality of categories provided in advance, and the frequency of documents within a category into which the sentence is classified is obtained. With respect to the feature values of the documents, various feature values such as one simply indicating the frequency of word appearance or one showing a value using tf−idf can be applied.

In terms of the relationship between an element in the generated sentence and the ethical risk factor information, a score may be calculated on the basis of a “statistical value” obtained by searching the ethical risk factor information using an element (word) in the generated sentence and coming up with the number of hits or calculating the hit rate. Alternatively, a score may be calculated by embedding words in the generated sentence using feature values and determining similarity to words in the information similarly expressed by feature values. In addition, a score can also be calculated by combining feature values of the generated words and determining similarity to words or documents in the information.

The methods for calculating the statistical value and the score described above are not limited to the above, and various methods may be employed.

### [Model Selection Part and Model Output Part]

The model selection part 103 selects a model on the basis of the risk determination result. The model selection part 103 receives a result of assessing at least one model determined by the risk determination part 102 and selects a model by determining whether or not to adopt the model on the basis of predetermined criteria. The model output part 104 outputs the selected model to the outside.

### [Processing Flow]

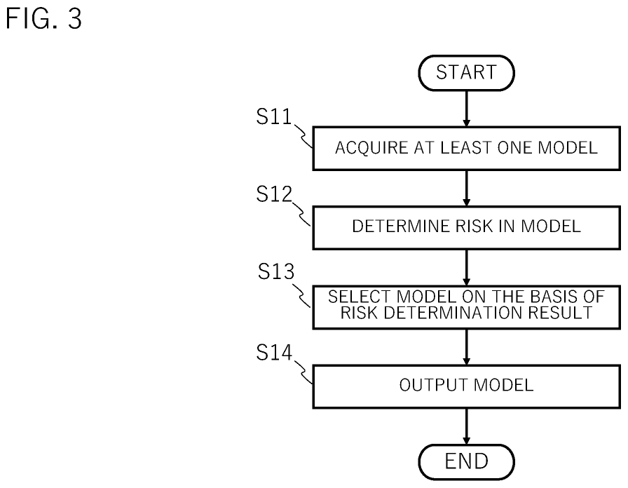

FIG. 3 is a flowchart showing a flow of processing performed by the risk assessment apparatus of the present example embodiment. As shown in the drawing, the model acquisition part 101 first acquires at least one explainable predictive model (step S11). Next, the risk determination part 102 determines risk in the at least one model on the basis of the acquired model and the stored ethical risk factor information (step S12). Then, the model selection part 103 selects a model on the basis of the determination result (step S13). Finally, the model output part 104 outputs the selected model (step S14).

### [Hardware Configuration]

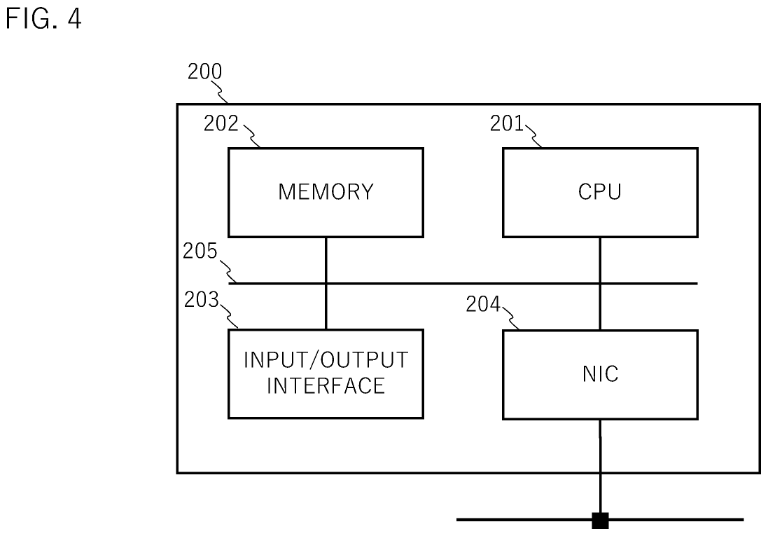

Next, the hardware configuration of the risk assessment apparatus relating to the first example embodiment will be described. FIG. 4 is a block diagram showing an example of the hardware configuration of the risk assessment apparatus relating to the first example embodiment.

The risk assessment apparatus 100 can be constituted by an information processing apparatus (computer) 200 and comprises the configuration illustrated in FIG. 4. For instance, the risk assessment apparatus 100 comprises a CPU (Central Processing Unit) 201, a memory 202, an input/output interface 203, and a NIC (Network Interface Card) 204, which is communication means. These elements are interconnected by an internal bus 205. The risk assessment apparatus 100 typically comprises an interface capable of communicating with a network via the NIC.

It should be noted that the configuration shown in FIG. 4 is not intended to limit the hardware configuration of the risk assessment apparatus 100. The risk assessment apparatus 100 may include hardware or functional elements not shown in the drawing. Further, the example of FIG. 4 does not limit the number of CPUs, etc., included in the risk assessment apparatus 100, and for instance, a plurality of CPUs may be included in the risk assessment apparatus 100.

The memory 202 is a RAM (Random Access Memory), ROM (Read-Only Memory), or auxiliary storage device (such as a hard disk).

The input/output interface 203 is means for interfacing a display device or an input device not shown in the drawing. For instance, the display device is a liquid crystal display. The input device is, for instance, a device that accepts user operations such as a keyboard or a mouse.

First, a model acquisition program is read from the memory 202 and executed by the CPU 201. The program receives at least one model generated by an external apparatus and stores the model in the memory 202. For instance, in the memory 202, memory spaces having address 1 and address 2 at the top are allocated in association with each other for models. The space starting with address 1 stores mathematical expression information of a model, and the space starting with address 2 stores information that makes the model explainable such as a model description and variable item labels.

Next, the CPU 201 starts executing a risk determination score calculation program. The program accesses the information, stored in address 2, that makes the model explainable and acquires a variable item label, for instance. In the case of the employment determination model described above, variable item label information such as the words “employment determination value,” “research subject,” “age,” and “test score” are acquired. The program refers to the mathematical expression information of the model stored in the associated space starting with address 1. As a result of this reference, the program recognizes the model as a predictive model in which variables forming a linear expression and another variable are connected by an equal sign and recognizes that the variables forming the linear expression “research subject,” “age,” and “test score” are explanatory variables and “employment determination value” is a target variable. Then, the program reads a document template, “{$target variable} is predicted by {$explanatory variable},” stored in the memory 202 and inserts the variable item label words of the explanatory variables “research subject,” “age,” and “test score” and the target variable “employment determination value” into the template to generate the sentence, “The employment determination value is predicted by the research subject, the age, and the test score.”

Next, the program performs clustering on the ethical risk factor information database stored in the memory 202 including the generated sentence by means of the computational processing of the CPU 201. Then, as an example, a risk determination score R is calculated on the basis of the frequency of documents in a cluster to which the generated sentence belongs as a result. As for the ethical risk factor information, available information is collected and stored in the database in advance before any operation is started, and the ethical risk factor information is further supplemented and accumulated thereafter.

Next, the CPU 201 starts executing a model selection program. The calculated R is compared with a reference value Ro for model selection. When R is smaller than Ro, the model is selected. Then, the program hands the information of the model stored in the spaces starting with address 1 and address 2 to a model output program. The model output program outputs the information of the selected model via the input/output interface 203.

### Effects

According to the risk assessment apparatus of the present example embodiment, the risk determination part 102 is able to determine potential ethical risks in an explainable predictive model generated by machine learning and the like using the ethical risk factor information, and the model selection part 103 is able to select a model on the basis of the determination result. Since it is possible to determine risk in a model using a large amount of the ethical risk factor information, risk assessment can be performed with high reliability. The risk assessment apparatus of the present example embodiment is able to assess risk in a generated model from an ethical perspective and remove high-risk models from candidates for implementation, making it possible to prevent a situation where a service or system is forced to be suspended due to ethical issues after a generated model has been implemented into the service or system.

### Second Example Embodiment

A risk assessment apparatus relating to a second example embodiment will be described in more detail with reference to the drawings.

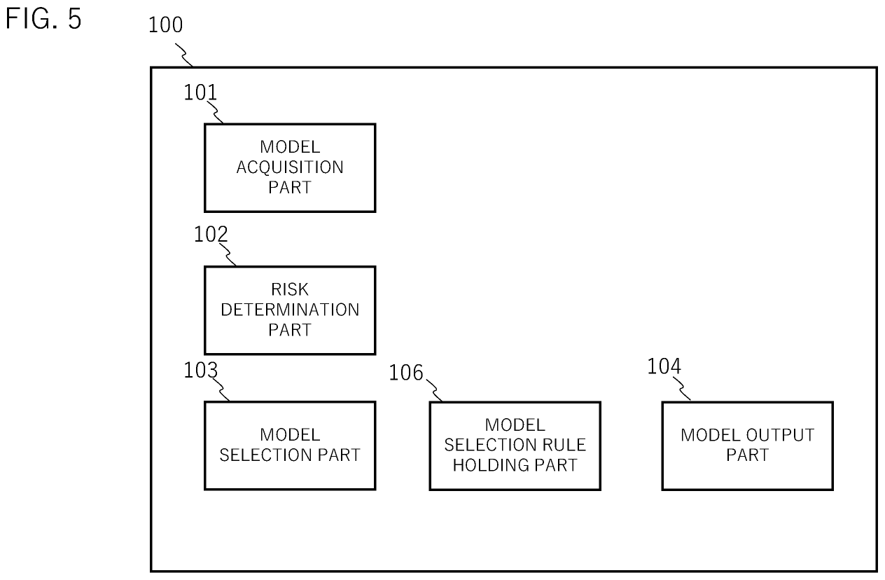

FIG. 5 shows an example of a block diagram of the risk assessment apparatus according to the second example embodiment. As shown in the drawing, the risk assessment apparatus 100 of the present example embodiment has the model acquisition part 101, the risk determination part 102, the model selection part 103, and the model output part 104. Since these elements have already been described, the description thereof will be omitted. In the present example embodiment, a model selection rule holding part 106 is newly provided.

The model selection rule holding part 106 holds a model selection rule for selecting a model from the at least one model.

For instance, a simple example of the model selection rule states that, when a calculated risk determination score exceeds a predetermined value, the model relating to this risk determination score should not be selected.

Further, in another example of the model selection rule, a list of information about specific ethical risk factors may be provided in the storage, and if a model contains any of the ethical risk factor information specified by the provided list, the model should not be selected regardless of its risk determination score. In other words, this rule does not select a model when it contains information even the mere presence of which (words, etc.) in a model is highly likely to damage the credibility of the model significantly, removing it from output candidates without calculating a risk determination score.

Further, one can use a rule that selects a model on the basis of a calculated risk determination score and the coefficients of the explanatory variables in the predictive formula of the at least one model.

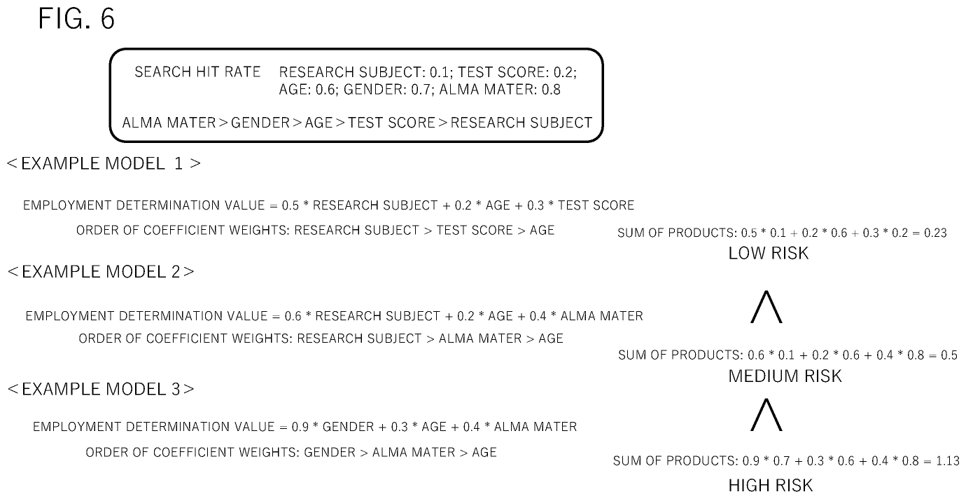

FIG. 6 is a drawing showing an example of the model selection rule stored in the model selection rule holding part 106 of the present example embodiment. Here, it is assumed that example models 1 to 3 are generated and acquired by the model acquisition part 101. We will also assume that the risk determination part 102 comes up with a risk determination score by calculating the search hit rate as a result of searching the ethical risk factor information holding part 105 using the item label of a component variable of a model. The search hit rate for each item is shown in the frame in the drawing. In other words, a score of 0.1 for the item “research subject”; 0.2 for “test score”; 0.6 for “age”; 0.7 for “gender”; and 0.8 for “alma mater.” Coefficients, determined through learning, are given to the items (variables) in the models.

Here, we will suppose that the model selection rule is based on the sum of the products of risk determination scores based on the search hit rates and the coefficient values for the variables in a model. As shown in FIG. 6, the resultant values are 0.23 for example model 1, 0.5 for example model 2, and 1.13 for example model 3. Therefore, as far as risk assessment is concerned, one can arrange the models in descending order of risk: example model 3, example model 2, and example model 1. Whether or not to select (adopt) any model, and if so, which model should be adopted can be determined by setting a predetermined reference value. The predetermined reference value can be appropriately set according to an actual operation (or trial) of the apparatus or the system.

### [Processing Flow]

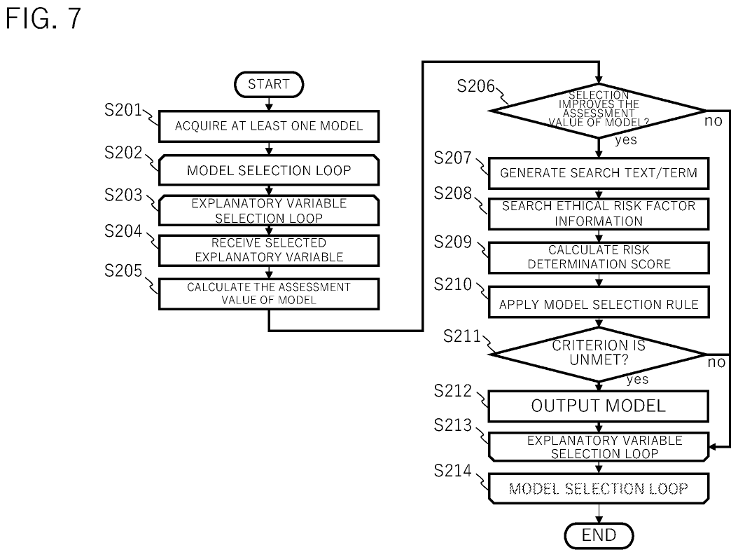

FIG. 7 shows a flow of processing performed by the risk assessment apparatus according to the present example embodiment. As shown in the drawing, the model acquisition part 101 first acquires at least one model (step S201). Next, a model selection loop (steps S202 to S214) starts in order for the model acquisition part 101 to perform processing on each model. Then, an explanatory variable selection loop (the steps S203 to S213), in which the model acquisition part 101 performs processing on each explanatory variable selected, starts. The model acquisition part 101 first receives a selected explanatory variable (the step S204). Next, the model acquisition part 101 assesses a model constituted by the received explanatory variable according to various information criteria (the step S205). As a result of the assessment, the model acquisition part 101 determines whether or not the assessment value of the model is improved by the selection (the step S206). If the assessment value improves, the risk determination part 102 generates a search text/term from the model (the step S207). If the assessment value does not improve, the model acquisition part 101 accepts another explanatory variable in a next iteration. Next, the risk determination part 102 searches the ethical risk factor information using the generated search text/term (the step S208). The risk determination part 102 calculates a risk determination score on the basis of the search result (the step S209). Next, the model selection part 103 applies the model selection rule to the score (the step S210). As a result of this, the model selection part 103 determines whether or not a risk assessment criterion described in the rule is met (the step S211), and if the risk assessment criterion is unmet, the model is adopted, the model output part 104 outputs the model (the step S212), and a next variable selection iteration starts. Conversely, if the risk assessment criterion is met, the model is not adopted and a next iteration starts. When all variable selection loops are executed, a next model selection loop begins, and the model acquisition part 101 accepts a selected variable for another model and repeats selecting models.

### Effects

As described in Processing Flow above, the risk assessment apparatus of the present example embodiment is capable of simultaneously selecting an explanatory variable and assessing risk since the risk determination score calculation process, performed by the risk determination part 102, and the model selection process are included in the iteration loop in which the model acquisition part 101 selects explanatory variables. Explanatory variable selection is assessed immediately by performing the explanatory variable selection by the model acquisition part 101 and the risk assessment by the risk determination part 102 in the same iteration loop, eliminating the need to select explanatory variables and assess risk in an exhaustive manner, and an effect of efficiently performing explanatory variable selection and risk assessment can be obtained even with an increased number of explanatory variables.

### [Hardware Configuration]

Next, the hardware configuration of the risk assessment apparatus relating to the second example embodiment will be described. The hardware configuration of the risk assessment apparatus according to the present example embodiment is the same as that of the first example embodiment. Therefore, the illustration thereof will be omitted, and the operation of the hardware will be outlined with reference to FIG. 4.

First, the model acquisition program is read from the memory 202 and executed by the CPU 201. The program receives at least one model generated by an external apparatus and stores the model in the memory 202. For instance, in the memory 202, memory spaces having address 1 and address 2 at the top are allocated in association with each other for models. The space starting with address 1 stores mathematical expression information of a model, and the space starting with address 2 stores information that makes the model explainable such as a model description and variable item labels. Here, an explanatory variable selected via the input/output interface 203 is received and stored in the addresses described above.

The program may pre-assess the model at this time. The model constituted by the received explanatory variable is assessed according to various information criteria, and an assessment value is calculated. The program may determine whether or not the assessment value reaches a predetermined level and may transition to the next risk determination score calculation process only when the assessment value reaches the predetermined level.

Next, the CPU 201 starts executing the risk determination program. The program accesses the information, stored in address 2, that makes the model explainable and acquires a variable item label, for instance. In the case of the employment determination model described above, variable item label information such as the words “employment determination value,” “research subject,” “age,” and “test score” are acquired. The program refers to the mathematical expression information of the model stored in the associated space starting with address 1. As a result of this reference, the program recognizes the model as a predictive model in which variables forming a linear expression and another variable are connected by an equal sign and recognizes that the variables forming the linear expression “research subject,” “age,” and “test score” are explanatory variables and “employment determination value” is a target variable.

The program searches the ethical risk factor information data stored in the memory 202 using the explanatory variable item labels “research subject,” “age,” and “test score” as search queries. As a result of the search, the program calculates the search hit rate and stores the result in the memory 202 for each variable.

Next, the CPU 201 starts executing the model selection program, and reads the model selection rule stored in the memory 202. Here, as an example, it is assumed that the model selection rule selects a model by having the CPU 201 calculate the sum of the products of the coefficients of the explanatory variables in the model and the search hit rates for the explanatory variables and determining whether or not the resultant value reaches a reference value. This computation is executed, and whether or not the computed value reaches the reference value is determined by comparing the two values. If the computed value does not reach the reference value, the model is selected (adopted) and outputted by the input/output interface 203. Conversely, if the computed value reaches the reference value, the model is not outputted and a next iteration starts, returning the process of receiving an explanatory variable again.

Some or all of the example embodiments above can be described as (but not limited to) the following modes.

### [Mode 1]

As the apparatus relating to the first aspect described above.

### [Mode 2]

The risk assessment apparatus preferably according to Mode 1, wherein the risk determination part in Mode 1 generates a sentence describing a model in a language for each of at least one model in Mode 1 on the basis of the relationship between elements in the at least one model and determines risk in the at least one model using at least one of the sentence and an element in the sentence, and the ethical risk factor information.

### [Mode 3]

The risk assessment apparatus preferably according to Mode 1, wherein the risk determination part calculates a risk determination score assessing risk in the at least one model on the basis of the at least one model and the ethical risk factor information, and the model selection part selects a model on the basis of the risk determination score.

### [Mode 4]

The risk assessment apparatus preferably according to Mode 2, wherein the risk determination part calculates a risk determination score assessing risk in the at least one model using at least one of the sentence and an element in the sentence, and the ethical risk factor information, and the model selection part selects a model on the basis of the risk determination score.

### [Mode 5]

The risk assessment apparatus preferably according to Mode 4, wherein the risk determination part calculates a risk determination score by calculating a statistical value indicating the relationship between at least one of the sentence and an element in the sentence, and the ethical risk factor information.

[Mode 6]

The risk assessment apparatus preferably according to any one of Modes 1 to 5 further having an ethical risk factor information holding part that holds the ethical risk factor information, wherein the risk determination part determines risk in the at least one model on the basis of the at least one model and the held ethical risk factor information.

### [Mode 7]

The risk assessment apparatus preferably according to any one of Modes 3 to 5, wherein a model selection rule holding part that holds a model selection rule, which is a rule for selecting a model from the at least one model, and the model selection part select a model from the at least one model on the basis of the risk determination score and the model selection rule.

[Mode 8]

The risk assessment apparatus preferably according to Mode 7, wherein the model selection rule is a rule that selects a model on the basis of the risk determination score and a coefficient of an explanatory variable in a predictive formula of the at least one model.

[Mode 9]

The risk assessment apparatus preferably according to Mode 7 or 8, wherein the model selection rule is a rule stating that a model relating to a calculated risk determination score exceeding a predetermined value is not selected.

[Mode 10]

The risk assessment apparatus preferably according to any one of Modes 7 to 9, wherein the model selection rule is a rule including a list of information about specific ethical risk factors and stating that, when a model contains the information on the list with respect to the ethical risk factor information specified by the list, regardless of a risk determination score, the model relating to the risk determination score is not selected.

### [Mode 11]

As the risk assessment method relating to the second aspect described above.

### [Mode 12]

As the program relating to the third aspect described above.

### [Mode 13]

A recording medium storing the program according to Mode 12.

Further, the disclosure of each Patent Literature cited above is incorporated herein in its entirety by reference thereto. It is to be noted that it is possible to modify or adjust the example embodiments or examples within the scope of the whole disclosure of the present invention (including the Claims) and based on the basic technical concept thereof. Further, it is possible to variously combine or select (or deselect) a wide variety of the disclosed elements (including the individual elements of the individual supplementary notes, the individual elements of the individual examples, and the individual elements of the individual figures) within the scope of the Claims of the present invention. That is, it is self-explanatory that the present invention includes any types of variations and modifications to be done by a skilled person according to the whole disclosure including the Claims, and the technical concept of the present invention.

### REFERENCE SIGNS LIST

100: risk assessment apparatus
101: model acquisition part
102: risk determination part
103: model selection part
104: model output part
105: ethical risk factor information holding part
106: model selection rule holding part
200: information processing apparatus (computer)
201: CPU
202: memory
203: input/output interface
204: NIC
205: internal bus

What is claimed is:

1. A risk assessment apparatus, comprising:
at least a processor; and
a memory in circuit communication with the processor,
wherein the processor is configured to execute program instructions stored in the memory to implement:
a model acquisition part that acquires at least one explainable predictive model;
a risk determination part that determines risk in the at least one model on the basis of the at least one model and ethical risk factor information, which is information that is an ethical risk factor;
a model selection part that selects a model on the basis of the result of risk determination; and
a model output part that outputs the selected model.

2. The risk assessment apparatus according to claim 1, wherein
the risk determination part generates a sentence describing a model in a language for each of the at least one model on the basis of the relationship between elements in the at least one model and determines risk in the at least one model using at least one of the sentence and an element in the sentence, and the ethical risk factor information.

3. The risk assessment apparatus according to claim 1, wherein
the risk determination part calculates a risk determination score assessing risk in the at least one model on the basis of the at least one model and the ethical risk factor information, and
the model selection part selects a model on the basis of the risk determination score.

4. The risk assessment apparatus according to claim 2, wherein
the risk determination part calculates a risk determination score assessing risk in the at least one model using at least one of the sentence and an element in the sentence, and the ethical risk factor information, and
the model selection part selects a model on the basis of the risk determination score.

5. The risk assessment apparatus according to claim 4, wherein
the risk determination part calculates a risk determination score by calculating a statistical value indicating the relationship between at least one of the sentence and an element in the sentence, and the ethical risk factor information.

6. The risk assessment apparatus according to claim 1, further comprising an ethical risk factor information holding part that holds the ethical risk factor information, wherein
the risk determination part determines risk in the at least one model on the basis of the at least one model and the held ethical risk factor information.

7. The risk assessment apparatus according to claim 3, wherein
a model selection rule holding part that holds a model selection rule, which is a rule for selecting a model from the at least one model, and the model selection part selects a model from the at least one model on the basis of the risk determination score and the model selection rule.

8. The risk assessment apparatus according to claim 7, wherein the model selection rule is a rule that selects a model on the basis of the risk determination score and a coefficient of an explanatory variable in a predictive formula of the at least one model.

9. The risk assessment apparatus according to claim 7, wherein the model selection rule is a rule stating that a model relating to a calculated risk determination score exceeding a predetermined value is not selected.

10. The risk assessment apparatus according to claim 7, wherein the model selection rule is a rule including a list of information about specific ethical risk factors and stating that, when a model contains the information on the list with respect to the ethical risk factor information specified by the list, regardless of a risk determination score, the model relating to the risk determination score is not selected.

11. A risk assessment method, comprising:
acquiring at least one explainable predictive model;
determining risk in the at least one model on the basis of the acquired model and ethical risk factor information, which is information that is an ethical risk factor;
selecting a model on the basis of the result of risk determination; and
outputting the selected model.

12. A non-transitory computer-readable recording medium, storing thereon a program being configured to make a computer to execute:
a process of acquiring at least one explainable predictive model;
a process of determining risk in the at least one model on the basis of the acquired model and ethical risk factor information, which is information that is an ethical risk factor;
a process of selecting a model on the basis of the result of risk determination; and
a process of outputting the selected model.

13. (canceled)
